(19) United States
(12) Patent Application Publication
(10) Pub. No.: US 2015/0136019 A1
(43) Pub. Date: May 21, 2015

(54) Pneumatic Surface Painting Frame

(71) Applicant: Joseph Bellamy, Houston, TX (US)

(72) Inventor: Joseph Bellamy, Houston, TX (US)

(21) Appl. No.: 14/084,952

(22) Filed: Nov. 20, 2013

(51) Int. Cl. B05B 3/18

(52) U.S. Cl. CPC B05B 3/18
USPC 118/315

(57) ABSTRACT

A pneumatically controlled painting frame is provided for painting large, open surfaces with a uniform coating of paint, primer, or other surface coating that is spray-applied. The device comprises a rectangular frame having a slidable paint spray rail within the frame. The paint spray rail is slidably controlled using compressed air, which forces the rail along the frame in a singular direction, while the compressed air draws the coating from a container for communication through a plurality of spray nozzles along one surface of the rail. The device is positioned against a surface, adjusted using jack screw base supports, connected to a compressor, and operated using a remote control, which activates the release of the compressed air through the system to allow one pass of the rail across the adjacent surface for coating the same.

### BACKGROUND OF THE INVENTION

1. Field of the Invention

The present invention relates to painting tools and paint spraying devices. More specifically, the present invention pertains to a paint spray frame that utilizes compressed air to control a spray rail that is slidably positioned within the frame. The assembly allows a user to paint an enlarged surface without using an individual sprayer, brush, or roller, while also not personally handling the same.

Painting large surfaces or large swaths of interior spaces can be quite labor intensive and require considerable time to accomplish. Generally painting contractors or individual homeowners will utilize paint rollers or paint sprayers and manually apply the paint using the tool. The user directs the paint onto the wall, covering the entire portion desired to be painted, and then makes more passes if more than one coating of paint is required. While this procedure is well known and is effective for painting interior and exterior surfaces, it is intensive, requires skill in application, and also exposes the user to paint splatter during the painting process.

Painting devices that facilitate painting enlarged surfaces or intricate designs have been disclosed in the art. Many of these devices are utilized in manufacturing areas for painting a design or painting a work piece in an assembly process, or on command from a control computer. These devices are well adept at applying primer, paint, and coatings onto objects, but these are generally large apparatuses that function with moveable work pieces in a repeating process. The present invention relates to a transportable wall painting frame that can be moved and positioned against a surface for coating the same, wherein the device takes the place of a manual painting process.

The present invention comprises a pneumatic paint spray frame that includes a slidable spray rail within a largely rectangular frame. An air compressor supplies high pressure air into the device, which controls linear motion of the rail along the length of the frame, while also supplying air for paint spray nozzles along the spray rail. The nozzles apply a coating to the wall surface adjacent to the frame, wherein the moving rail is capable of applying coverage over a distance defined by the frame length in a continuous, even coating along the surface. The device can be operated by remote and the frame can be positioned using rollers and height-adjustable supports.

Overall, the present invention is intended to vastly improve the painting process, particularly for interior or exterior painting. The device can be positioned adjacent to a wall, initiated, and a coating of paint is applied to the wall. Careful masking of the wall prevents overspray, while the device can make several passes if desired. The goal is to improve efficiency of painting planar walls, and remove manual painting tools that are slow, messy, and inconvenient to use.

2. Description of the Prior Art

Devices have been disclosed in the prior art that relate to painting devices. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,044,665 to Cannell discloses a computerized apparatus for applying at least one graphic to a surface. The apparatus comprises a portable scaffolding system that can be adjusted to accommodate the dimensions of the surface to receive the graphic. A host device supports a head attachment, wherein the head attachment applies the graphic to the surface while the host device controls the positioning of the head attachment within the scaffolding. A computer controls a series of motors that positionally control the host device for creating a unique design on the surface. While providing a frame for painting a surface, the Cannell device utilizes electric motors for precise control of a spray attachment head. The present invention is directed to spraying a continuous, uniform coating on a surface for priming or painting purposes, as opposed to applying intricate designs to a surface.

U.S. Pat. No. 6,467,978 to Tideman, Jr. discloses an image reproduction system that is similar to the Cannell apparatus. The Tideman, Jr. device comprises a guide rail having a longitudinal axis, a carriage that can move along the guide rail, and a medium head assembly for applying the paint coating to the surface. The medium head includes a plurality of airbrushes that individually produce a single pixel of various colors and shades. The device is computer controlled and well adapted for recreating an image through digital, pixel printing. Similar to Cannell, the Tideman, Jr. device fails to provide a surface coating frame that is adapted for complete wall coverage and efficient at the same. The present invention is designed for free field coatings of paint or primer, while the prior art is related to digital devices for image creation. The present invention is a simple pneumatic device that requires no programmed algorithm for operation.

Finally, U.S. Patent Publication No. 2006/0275552 to Vendlinkski discloses an automated paint application apparatus that utilizes an apparatus that supports a movable paint assembly that is controlled by digital programming. The apparatus comprises a pair of vertical support members and a horizontally secured beam, while a track between the vertical support members supports the paint assembly thereon. The apparatus and system is adapted for use painting large-scale items, such as buildings, walls, and billboards. While suitable for these items, the Vendlinkski device differs from the present invention in that no programming is necessary to operate the present device. The present invention utilizes a compressed air means and a series of valves to control motion of a spray rail within a frame, while spray nozzles of the rail receive pressure from the same compressed air means.

The present invention provides a means for coating a surface using a remote-operated spray system, whereby a uniform coating of paint, primer, or similar surface coating is applied to a surface using a pneumatically controlled spray rail within a frame. The frame includes connections to the compressed air, while the paint is drawn from a suspended container. The compressed air controls the motion of the rail and the communication of paint through the moving rail, where a single pass of the surface is operably controlled by the user.

It is submitted that the present invention is substantially divergent in design elements from the prior art, and consequently it is clear that there is a need in the art for an improvement to existing painting devices. In this regard the instant invention substantially fulfills these needs.

### SUMMARY OF THE INVENTION

In view of the foregoing disadvantages inherent in the known types of painting devices now present in the prior art, the present invention provides a new painting frame device, wherein the same can be utilized for providing convenience for the user when painting large surfaces in an automated process that reduces error and ensures uniform application of a surface coating.

It is therefore an object of the present invention to provide a new and improved surface painting device that has all of the advantages of the prior art and none of the disadvantages.

It is another object of the present invention to provide a surface painting device that provides a user with coating a surface with a uniform layer of material without using hand tools such as paint rollers, hand sprayers, or brushes.

Another object of the present invention is to provide a surface painting device that affords a user with the ability to uniformly coat a surface using a pneumatically operated and remotely controlled device that does not require the user to interact with the coating material (e.g. paint) or the tool.

Yet another object of the present invention is to provide a surface painting device that utilizes compressed air to operate a moveable paint rail within a paint frame, wherein compressed air moves the rail in a singular direction for making one pass over a surface, whereby coating material is spray-applied uniformly on the adjacent surface.

Another object of the present invention is to provide a surface painting device that requires a reservoir of surface coating and compressed air to operate, while digital programming of the tool is not required for operation.

Yet another object of the present invention is to provide a surface painting device that includes jack screw supports along the base of the frame for changing the position and orientation of the frame with respect to the adjacent surface.

Another object of the present invention is to provide a surface painting device that can be readily cleaned after use by communicating water through the device rather than surface coating material, wherein the water is collected from the spray rail using a spray rail cover that collects the water from the rail and any residual coating material.

A final object of the present invention is to provide a surface painting device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of the painting device of the present invention.

FIG. 2 shows a schematic view of the pneumatic connections of the present invention.

FIG. 3 shows a view of the jack screw base support of the painting device frame.

FIG. 4 shows a view of the present invention in a working state, being supplied compressed air, spraying coating material along a surface as the spray rail moves from one end of the frame to the other.

FIG. 5 shows an exploded view of the spray rail cover of the present invention, which diverts and collects fluid being communicated through the device during cleaning operations.

### DETAILED DESCRIPTION OF THE INVENTION

Reference is made herein to the attached drawings. Like reference numerals are used throughout the drawings to depict like or similar elements of the pneumatic painting device. For the purposes of presenting a brief and clear description of the present invention, the preferred embodiment will be discussed as used for painting large, exposed surfaces with a uniform coating of surface material applied using compressed air. The figures are intended for representative purposes only and should not be considered to be limiting in any respect.

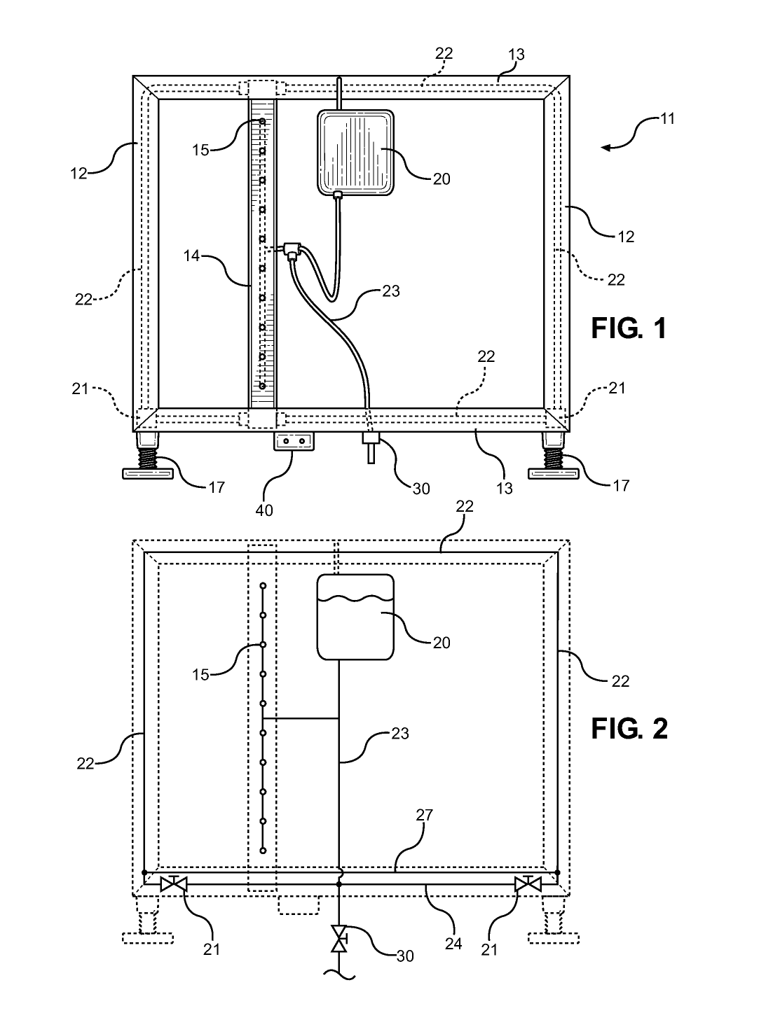

Referring now to FIG. 1, there is shown a view of the pneumatic painting device of the present invention in a working state. The device comprises a painting frame 11 having a first and second upright frame end member 12 connected to an upper and lower frame member 13, wherein the members form a largely rectangular shape. Within the interior of the rectangular painting frame 11 is a slidable paint rail 14, which is slidable along the length of the frame 11 and between its end member 12 interior extents. The paint rail 14 comprises a plurality of liquid material spray nozzles 15 disposed along one surface thereof for communicating paint, primer, or other liquid coating material therethrough and onto an adjacent surface when ejected through the nozzles 15.

Positioning of the spray rail 14 is controlled by a pneumatic system that utilizes compressed air to force the rail 14 from one end of the frame 11 to the other and further to cause the coating material to communicate from an attached reservoir 20 through the spray nozzles 15. A compressed air attachment valve 30 is provided along the frame 11, which communicates high pressure air through internal conduits 22 that force the rail 14 from one side to initiate motion thereof as the spray nozzles 15 are communicating a coating material by way of a compressed air line 23 connected to the coating material reservoir 20.

The apparatus is adapted to be operated by remote, wherein a user can control the operation of directional valves 21 within the frame 11 for communicating compressed air to one side of the rail 14 only, such that one side thereof is pressurized while the opposite side is not, initiating sliding motion thereof. A user can initiate the compressor and remotely activate the valves 30, 21 by way of a remote sensor 40. Therefore, the device can be positioned against a large, open surface that is masked in preparation for spray painting, whereafter the frame 11 is adjusted by way of adjustable supports 17, while the user can initiate the communication of fluid through the spray rail 14 while initiating its motion from one end of the frame 11 to the other. The operation of the valves allows a single pass of the rail 14 across the surface, where the remote control operates valve switching.

Referring now to FIG. 2, there is shown a schematic diagram of the pneumatic system within the frame of the present invention. A compressed air valve 30 accepts pressurized air from a compressor device. The compressed air is first routed through a paint pressure line 23 to communicate paint from a reservoir 20 and into the spray rail for ejection through the spray nozzles 15. The compressed air is also diverted into the frame internal conduits 22 to control the position of the spray rail within the frame. A first and second rail directional valve 21 controls which side of the rail is pressurized, and thus the direction of travel of the rail within the frame. The directional valves 21 can be manually controlled by remote, or they can automatically switch when the rail reaches an end extent of the frame, wherein the valves automatically switch for diverting compressed air to the opposite side of the rail for a subsequent pass over the adjacent surface.

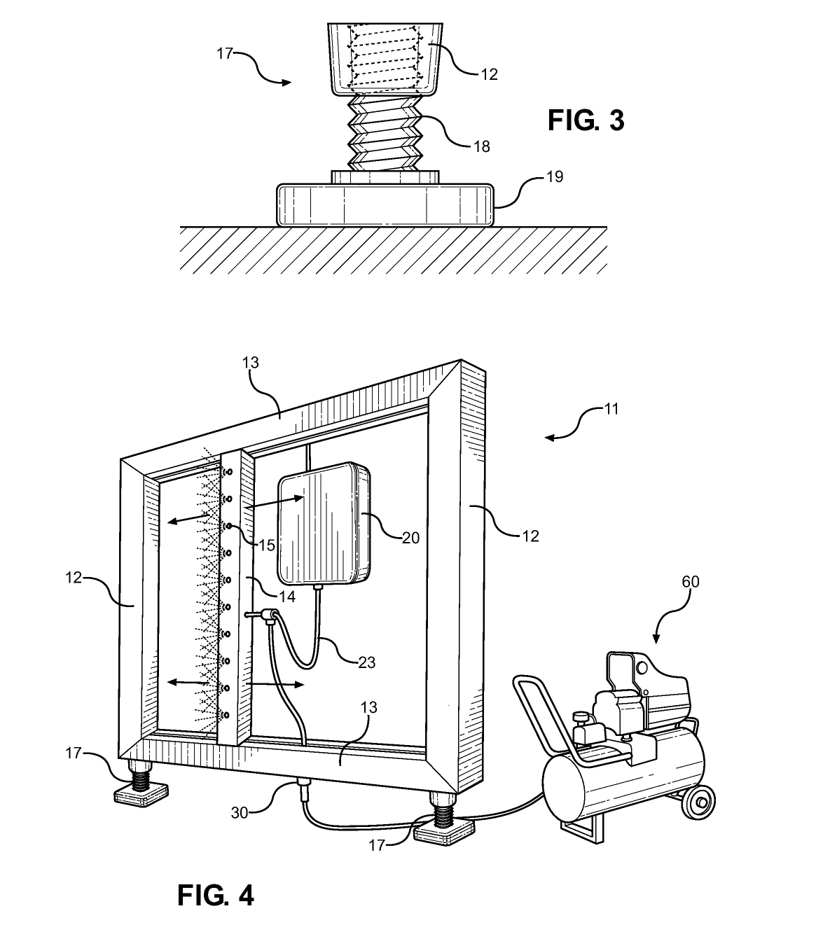

Referring now to FIG. 3, there is shown a view of the jack screw support 17 at the base of the frame. The support 17 comprises a threaded member 18 that is threadably connected into the lower frame member or frame end member 12, along with a base pad member 19 or a roller wheel support (not shown). The jack screw 17 assembly allows the end of the frame to be lifted or lowered with respect to the ground surface, thereby allowing the device to be positioned adjacent to a wall surface and leveled with respect thereto. This ensures the spray rail will move in a level direction along the wall surface, or at least in parallel swaths therealong. The jack screw 17 may be manually threaded or may include a small electric motor for remotely positioning the frame member with respect to the ground support. Yet another embodiment is providing for a smooth member that is controlled by pneumatic raising and lowering action. This embodiment uses the compressed air to raise and lower each jack.

Referring now to FIG. 4, there is shown a view of the pneumatic painting device of the present invention in a working state, connected to an air compressor 60 that supplies motive input for the spray rail 14 and for communication of fluid from the reservoir 20 and into the spray rail 13. The device operates by controlling the compressed within the frame 11, which controls the direction of travel of the rail 14 and the spray 15 of fluid from the rail 14 and from an attached reservoir 20. The spray rail 14 is capable of movement within the frame 11 from one end 12 to the other, while the ends of the rail 14 are supported within the upper and lower frame members 13. The compressed air is accepted through a valve 30, which pressurizes the system within the frame 11 and within the paint compressed air line 23.

In operation, the device is situated adjacent to a masked wall with the spray nozzles 15 directed towards the exposed wall surface. The jack screws 17 of the frame 11 are adjusted to position the frame 11 as desired from the ground, whereafter the compressor 60 is connected to the device. The user can then remotely operate the main valve 30 and the internal rail direction valves for slidable control of the rail 14. The paint is communicated through the rail and nozzles 15 thereon in a continuous, uniform fashion for applying a uniform coating of paint, primer, or other coating material to the adjacent surface. After a single pass, the rail 14 can be reversed and sent the opposite direction for a subsequent layer of paint.

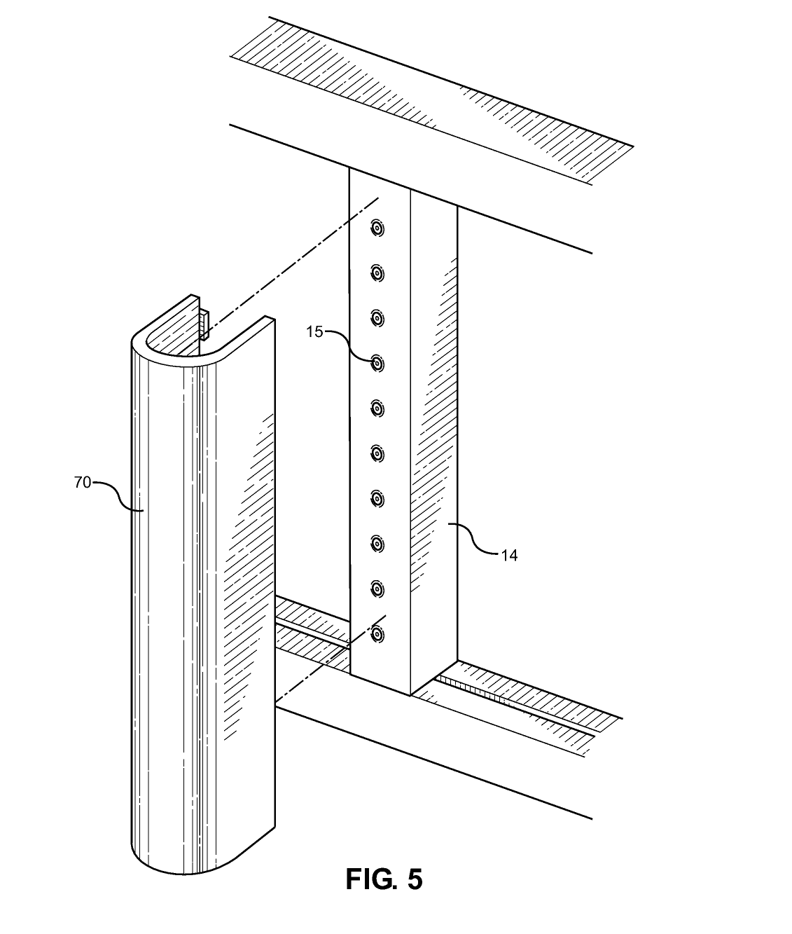

Referring finally to FIG. 5, there is shown a view of a spray rail cover 70 that is attachable to the nozzle-side of the spray rail 14 for cleaning purposes. The cover 70 secures over the nozzles 15 as the user communicates water through the system. A reservoir of water and/or paint thinner is utilized to flush out paint or coating residue from the spray rail 14 and from the nozzles 15. To prevent the water and residual coating material from being freely dispensed into the environment, the cover 70 diverts the fluid to the base of the frame for collection and subsequent disposal of the fluid. In this way, the device is readily cleanable after each use in the same way the device operates to paint surfaces.

When painting a large area, it may be extremely time-consuming for a craftsman or a do-it-yourself painter to efficiently cover the entire area and ensure the coverage is uniform. Because the painting is being done largely by hand, the job may turn out unevenly, with missed sections or uneven coats of paint. The mess involved with a hand-painted area may involve dripping or running, which requires extensive and time-consuming clean up. More money may be spent on the project, because it requires multiple painters to get the job done.

The present painting device comprises a controlled spray frame device that is particularly suited for uniform coverage of open wall spaces. An air supply hose permits air to flow through the device, which activates the movement of the side to side motion of the spray rail. Once the spray rail reaches one end of the frame, it either stays in position until the valves are switched by the user, or the valves are switched automatically to push the rail the opposite direction. The frame itself is raised by the jack screws or the air lift members to control the positioning of the frame with respect to the ground. Attached ground wheels permit the device to be wheeled into position adjacent to a wall surface prior to operation. Once positioned, the device permits hands-free painting by allowing the individual to set it up and control the device remotely.

Overall, the device easily turns a project that previously may have taken several days into a project that can take a few hours. The device saves a professional painter or a do-it-yourself craftsman hours or even days of work on a specific job, allowing him or her to focus on other projects while the painting is taking place. The device is suited for saving valuable time and money for everyone involved, while also permitting uniform coats of paint over a desired surface.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pneumatic painting device, comprising:
a frame having a first and second frame end member and an upper and lower frame member forming a substantially rectangular frame;
a paint rail slidably positioned within said frame, said paint rail having a plurality of liquid material spray nozzles disposed along a surface thereof;
a pneumatic system within said frame that is adapted to control said paint rail position and communicate fluid through said paint rail nozzles;
said pneumatic system comprising
a compressed air valve adapted to connect to an air compressor;
a liquid reservoir;
a paint pressure line connecting to said compressed air valve and said liquid reservoir to said paint rail nozzles;
internal conduits within said frame that are adapted to apply compressed air to one side of said paint rail or the other;
a first and second rail directional valve for controlling said compressed air in said internal conduits.

2) The device of claim 1, further comprising a remote control sensor for operably operating said compressed air valve.

3) The device of claim 1, further comprising a remote control sensor for operably operating said compressed air valve and said first and second rail directional valve.

4) The device of claim 1, wherein said first and second rail directional valve are automatically switched when said rail reaches an extent within said frame.

5) The device of claim 1, further comprising a first and second adjustable supports.

6) The device of claim 5, wherein said adjustable supports further comprise threaded jack screws.

7) The device of claim 5, wherein said adjustable supports further comprise pneumatically operated supports.

8) The device of claim 5, wherein said adjustable supports further comprise wheeled supports.

9) The device of claim 1, further comprising a spray rail cover that is adapted to shroud said nozzles and collected fluid exiting therefrom.
